(19) United States
(12) Patent Application Publication
(10) Pub. No.: US 2007/0273986 A1
(43) Pub. Date: Nov. 29, 2007

(54) Objective lens, lens drive mechanism, optical pickup apparatus, and method for assembling the same

(75) Inventor: Nobuyuki Kajita, Higashihiroshima-shi (JP)

Correspondence Address: MORRISON & FOERSTER LLP, 1650 TYSONS BOULEVARD, SUITE 400, MCLEAN, VA, 22102, US

(73) Assignee: SHARP KABUSHIKI KAISHA, Osaka-shi (JP)

(21) Appl. No.: 11/802,844

(22) Filed: May 25, 2007

(30) Foreign Application Priority Data
May 25, 2006 (JP) 2006-145989

(51) Int. Cl. G02B 7/02

(52) U.S. Cl. 359/811

(57) ABSTRACT

An objective lens, a lens drive mechanism, an optical pickup apparatus, and a method for assembling the same, that are capable of making the apparatuses lighter and keeping the weight balance in a well-balanced state are provided. An objective lens recess portion is formed at a position that is symmetrical, with respect to the optical axis, to a gate remainder on a objective lens. In a state where the objective lens is held on a counterbore portion of a lens holder, the objective lens is rotated about the optical axis thereof to a desired position, and then an adhesive is applied to a portion facing the gate remainder and a portion facing the objective lens recess portion, of the counterbore portion of the lens holder.

### CROSS-REFERENCE TO RELATED APPLICATION

This application claims priority to Japanese Patent Application No. 2006-145989, which was filed on May 25, 2006, the contents of which, are incorporated herein by reference, in their entirety.

### BACKGROUND OF THE INVENTION

1. Field of the Invention

The present invention relates to an objective lens, a lens drive mechanism, an optical pickup apparatus, and a method for assembling the same.

2. Description of the Related Art

FIG. 12 is a cross-sectional view of a lens driving apparatus 1 according to conventional techniques. FIG. 13 is a plan view of an objective lens 2 and a lens holder 3 according to the conventional techniques. FIG. 14 is a view schematically showing an optical pickup apparatus according to the conventional techniques. As shown in FIG. 14, a predetermined amount of a laser beam radially emitted from a light source 4 is reflected by a beam splitter 5, and is changed into a substantially parallel beam when traveling via a collimator lens 6. The substantially parallel beam is reflected by an erecting mirror 7, travels via the objective lens 2, and is irradiated on a recording disk 8. The reflected beam including information modulated by the recording disk 8 travels via the objective lens 2, the erecting mirror 7, and the collimator lens 6. A predetermined amount of the beam is transmitted through the beam splitter 5. Then, the beam travels via a beam processing lens 9 and is incident on a detecting element 10. The detecting element 10 performs a light-to-voltage conversion, and sends a processed signal to a control circuit (not shown).

The objective lens 2 is made of a molded article (see Japanese Unexamined Patent Publications JP-A 2002-243915 and JP-A 2004-342215, for example). FIGS. 15A and 15B show the objective lens 2 according to the conventional techniques. FIG. 15A is a plan view of the objective lens 2. FIG. 15B is a cross-sectional view of the objective lens 2 taken along the line A-A′. FIGS. 16A and 16B show the lens holder 3 according to the conventional techniques. FIG. 16A is a plan view of the lens holder 3. FIG. 16B is a cross-sectional view of the lens holder 3 taken along the line B-B′. In the case of a molded article, a gate 11 is formed through which a molding material is to be poured into a mold, as shown in FIG. 15A. After molding, when a product is removed from the mold, the gate 11 is attached to a part of the product, and a finished product is obtained by removing the gate 11 in post-treatment (gate process). A part of the gate 11 remains on the part of the finished product, and is referred to as a gate remainder 11a.

A part of the circular circumference of the objective lens 2 according to the conventional techniques is provided with a flat portion 2a, thereby preventing the gate remainder 11a from protruding outward in the radial direction from a virtual circular circumference R1. As shown in FIGS. 16A and 16B, a lens attachment hole 3a in the shape of a cylindrical hole is formed in the lens holder 3 to which the objective lens 2 is fixed. The objective lens 2 is fitted to the lens attachment hole 3a of the lens holder 3, the objective lens 2 is rotated, and the quality of a laser beam emitted through the objective lens 2 is checked, and then the objective lens 2 is attached to the lens holder 3 using an adhesive 12. A plurality of grooves 3b that are to be filled with an adhesive may be formed in advance in the lens holder 3 such that the grooves 3b are along the circumferential portion of the objective lens 2 fitted to the lens attachment hole 3a.

In addition to the fact that objective lens 2 according to the conventional techniques is asymmetrical, the fact that there is a difference from device to device in the relative position of the objective lens 2 with respect to the lens holder 3 causes the following problem. The rotational balance with respect to a reference X axis (indicated by the line X in FIG. 13) and a reference Y axis (indicated by the line Y in FIG. 13) of the lens holder 3 after the objective lens has adhered thereto is disturbed, and thus the dynamic characteristics of the lens driving apparatus 1 are disturbed, so that the accuracy in tracing the recording disk 8 may be deteriorated, resulting in a deterioration in the quality of signals. A method is conceivable in which the influence of disturbance of rotational balance (imbalance) is reduced by increasing the mass of the lens holder 3 and other components to the extent that the influence of asymmetry of the objective lens 2 is eliminated, but this method deteriorates the control characteristics, and gives a negative influence such as impeding the tracing of the recording disk 8 rotating at a high speed.

### SUMMARY OF THE INVENTION

Objects of the invention are to provide an objective lens, a lens drive mechanism, an optical pickup apparatus, and a method for assembling the same, that are capable of making apparatuses lighter and keeping the weight balance in a well-balanced state.

The invention provides an objective lens mounted on a lens drive mechanism of an optical pickup apparatus that performs at least one of reading out information recorded on a recording medium and writing information onto a recording medium, by irradiating the recording medium with a beam from a light source, comprising:

a lens composed of a molded piece, having a gate remainder that is a part of a gate left in molding, and having a centroid positioned on its optical axis.

According to the invention, the gate remainder is on the lens, but the centroid of the lens is on its optical axis. Thus, the weight balance of the objective lens can be kept in a well-balanced state. Accordingly, the weight balance of a component holding the objective lens also can be kept easily and in a well-balanced state.

Accordingly, compared with conventional techniques, the dynamic characteristics of the apparatus including the objective lens can be stabilized, and a recording medium can be accurately traced. It is possible to keep the weight balance in a well-balanced state without increasing the mass of a component for holding the objective lens and the like, and thus the entire apparatus can be made lighter. Compared with, for example, a case in which the mass of the above-described component is increased, the control characteristics can be improved, and a disk rotating at a high speed can be easily traced.

Moreover, in the invention, it is preferable that a recess portion is formed on the objective lens at a position that is symmetrical, with respect to the optical axis, to the gate remainder formed on a peripheral side in a radial direction.

According to the invention, the gate remainder is left on the peripheral side in the radial direction of the objective lens. On the objective lens, a recess portion is formed at the position that is symmetrical to the gate remainder with respect to the optical axis. In a state where the objective lens is held on the component for holding the objective lens, the objective lens is rotated about the optical axis thereof to a desired position, and then an adhesive or the like is applied to the vicinity of the gate remainder and the vicinity of the recess portion. Thus, the objective lens can be fixed to the above-described component, and the component and the objective lens can be kept in a well-balanced state without disturbing the weight balance.

Moreover, in the invention, it is preferable that the gate remainder and the recess portion are fixed to a lens holder through an adhesive.

According to the invention, the objective lens is fixed to the lens holder through an adhesive at the gate remainder and the recess portion. Thus, the weight balance of the lens holder and the objective lens can be reliably and easily kept in a well-balanced state.

Moreover, in the invention, it is preferable that the gate remainder and the recess portion are arranged on an inner side in a radial direction of a virtual circular circumference of the lens, and a remaining portion obtained by eliminating the lens on which the gate remainder is left and the recess portion is formed, from a virtual lens formed by the virtual circular circumference, is defined to have the same volumes at symmetrical positions with respect to the optical axis.

According to the invention, the remaining portion obtained by eliminating the lens on which the gate remainder is left and the recess portion is formed, from the virtual lens formed by the virtual circular circumference, is defined to have the same volumes at symmetrical positions with respect to the optical axis. Thus, the weight balance of the lens holder and the objective lens can be kept in a well-balanced state in advance, before being filled with an adhesive. When the amount of an adhesive used for filling is managed to be the same at symmetrical positions with respect to the optical axis, it is possible to keep the weight balance in a well-balanced state without disturbing the weight balance.

Moreover, in the invention, it is preferable that the gate remainder is left on a peripheral side in the radial direction of the lens, and a projecting portion having the same volume as the gate remainder is provided at a position that is symmetrical, with respect to the optical axis, to the gate remainder on the lens.

According to the invention, the gate remainder is left on the peripheral side in the radial direction of the lens, and a projecting portion having the same volume as that of the gate remainder is provided at the position that is symmetrical, with respect to the optical axis, to the gate remainder on the lens. Thus, without providing the component for holding the objective lens with an additional component, the weight balance of the above-described component and the objective lens can be kept in a well-balanced state.

Moreover, in the invention, it is preferable that the gate remainder and the projecting portion are fixed to a lens holder through an adhesive.

According to the invention, the objective lens is fixed to the lens holder through an adhesive at the gate remainder and the projecting portion. Thus, the weight balance of the lens holder and the objective lens can be reliably and easily kept in a well-balanced state.

Furthermore, the invention provides a lens drive mechanism comprising an objective lens including a lens composed of a molded piece, having a gate remainder that is a part of a gate left in molding, and having a centroid positioned on its optical axis; and a lens holder on which an objective lens is mounted.

According to the invention, the gate remainder is on the lens, but the centroid of the lens is on the optical axis of the lens. Thus, the weight balance of the objective lens can be kept in a well-balanced state. Accordingly, the weight balance of a lens holder on which the objective lens is mounted also can be kept easily and in a well-balanced state.

Moreover, in the invention, it is preferable that the lens holder holds the objective lens such that the objective lens can rotate about the optical axis thereof.

According to the invention, in a state where the objective lens is held on the lens holder, the objective lens is rotated about the optical axis thereof to a desired position, and then the objective lens is unrotatably fixed to the lens holder. Thus, it is possible to realize the lens drive mechanism that keeps the weight balance in a well-balanced state.

Moreover, in the invention, it is preferable that the gate remainder is left on a peripheral side in a radial direction of the lens,

a projecting portion having the same volume as that of the gate remainder is provided at a position that is symmetrical, with respect to the optical axis, to the gate remainder on the lens, and

a plurality of groove portions that can accommodate the gate remainder and the projecting portion are arranged on the lens holder such that adjacent groove portions are formed at an equal angle.

According to the invention, the objective lens is provided with the projecting portion having the same volume as that of the gate remainder, at the position that is symmetrical to the gate remainder with respect to the optical axis. In a state where the objective lens is held on the lens holder, the objective lens is rotated about the optical axis thereof to a desired position, and then an adhesive or the like is applied to the vicinity of the gate remainder and the vicinity of the projecting portion. Thus, the objective lens can be fixed to the lens holder, and the weight balance of the lens holder and the objective lens can be kept in a well-balanced state without disturbing the weight balance.

The invention provides an optical pickup apparatus on which the lens drive mechanism is mounted.

According to the invention, an optical pickup apparatus that keeps, in a well-balanced state, the weight balance of the lens holder on which the objective lens is mounted can be realized.

Moreover, in the invention, it is preferable that a collimator lens having an adjusting section for adjusting rotation about the optical axis is provided on an optical path between the objective lens and a light source of the optical pickup apparatus including the lens drive mechanism.

According to the invention, the rotation of the collimator lens about the optical axis is adjusted by the adjusting section, and thus the quality of a beam from the light source can be optimized without causing weight imbalance of the lens holder.

Moreover, the invention provides a method for assembling a lens drive mechanism of an optical pickup apparatus, comprising:

a step of holding an objective lens on a counterbore portion that is formed in a lens holder in advance, the objective lens composed of a molded piece, having a gate remainder that is a part of a gate left in molding and is left on a peripheral side in radial direction of the lens, and a recess portion or projecting portion being formed at a position that is symmetrical to the gate remainder with respect to an optical axis; and

a step of applying an adhesive to a portion facing the recess portion or projecting portion, of the counterbore portion of the lens holder, and applying an adhesive in the same amount as the amount of the adhesive, to a portion facing the gate remainder, of the counterbore portion of the lens holder.

According to the invention, in a state where the objective lens is held on the counterbore portion of the lens holder, an adhesive is applied to a portion facing the recess portion or projecting portion, of the counterbore portion of the lens holder, and an adhesive in the same amount as the amount of the adhesive is applied to a portion facing the gate remainder. In this manner, the amount of the adhesive applied is defined to be the same at the symmetrical positions with respect to the optical axis. Thus, the weight balance of the lens holder and the objective lens can be kept precisely and in a well-balanced state.

Moreover, in the invention, it is preferable that, in the step of applying the adhesive, the adhesive is dropped onto the portion facing the recess portion on the objective lens, of the counterbore portion of the lens holder, and the portion facing the gate remainder such that the adhesive does not bulge out from the counterbore portion of the lens holder.

According to the invention, the adhesive is dropped onto the portion facing the recess portion, of the counterbore portion of the lens holder, and the portion facing the gate remainder such that the adhesive does not bulge out from the counterbore portion of the lens holder. Thus, the amount of the adhesive applied is defined to be the same to the extent possible at the symmetrical positions with respect to the optical axis. In this manner, it is possible to keep the weight balance precisely and in a well-balanced state.

Moreover, in the invention, it is preferable that the method further comprises a step of adjusting the amount of the adhesive used for filling such that the objective lens is fixed to the lens holder, while checking the balance of the lens holder.

According to the invention, in a state where the objective lens is held on the lens holder, the amount of the adhesive used for filling is adjusted while checking the balance of the lens holder. When the amount of the adhesive used for filling is fine adjusted in this manner, the weight balance of the lens holder can be kept accurately and in a well-balanced state.

Moreover, the invention provides a method for assembling an optical pickup apparatus, comprising:

a step of holding an objective lens on a counterbore portion that is formed in a lens holder in advance, the objective lens composed of a molded piece, having a gate remainder that is a part of a gate left in molding and is left on a peripheral side in radial direction of the lens, and a recess portion or projecting portion being formed at a position that is symmetrical to the gate remainder with respect to an optical axis;

a step of applying an adhesive to a portion facing the recess portion or projecting portion, of the counterbore portion of the lens holder, and applying an adhesive in the same amount as the amount of the adhesive, to a portion facing the gate remainder, of the counterbore portion of the lens holder;

a step of checking a balance of the lens holder and aberration of a beam emitted from a light source of the optical pickup apparatus, after the step of applying the adhesive; and

a step of optimizing the aberration based on check results of the balance and the aberration.

According to the invention, in a state where the objective lens is held on the counterbore portion of the lens holder, an adhesive is applied to a portion facing the recess portion or projecting portion, of the counterbore portion of the lens holder, and an adhesive in the same amount as the amount of the adhesive is applied to a portion facing the gate remainder. After the objective lens is fixed to the lens holder using the adhesive, the balance of the lens holder and the aberration of a beam are checked. Based on the check results, the aberration is optimized. Thus, it is possible to realize the optical pickup apparatus including the lens drive mechanism, that can improve the control characteristics.

### BRIEF DESCRIPTION OF THE DRAWINGS

Other and further objects, features, and advantages of the invention will be more explicit from the following detailed description taken with reference to the drawings wherein:

FIG. 1 is a plan view of a lens drive mechanism according to a first embodiment of the invention;

FIGS. 2A and 2B show the objective lens according to the first embodiment of the invention, wherein FIG. 2A is a plan view of the objective lens, and FIG. 2B is a cross-sectional view of the objective lens taken along a virtual plane including an optical axis thereof;

FIG. 3 is a plan view of the objective lens and the lens holder according to the first embodiment;

FIGS. 4A and 4B show an objective lens according to a second embodiment of the invention, wherein FIG. 4A is a plan view of the objective lens, and FIG. 4B is a cross-sectional view of the objective lens taken along a virtual plane including an optical axis thereof;

FIG. 5 is a plan view of the objective lens and a lens holder according to the second embodiment;

FIGS. 6A and 6B are views showing a lens holder, wherein FIG. 6A is a plan view of the lens holder, and FIG. 6B is a cross-sectional view of the lens holder;

FIGS. 7A and 7B are views showing the relationship between the objective lens and a lens holder according to a partially modified example of the second embodiment, wherein FIG. 7A is a plan view of the lens holder and other components, and FIG. 7B is a cross-sectional view of the lens holder and other components;

FIGS. 8A through 8C show the main portions of an optical pickup apparatus according to a third embodiment, wherein FIG. 8A is a plan view of the objective lens and the lens holder, and FIG. 8B is a cross-sectional view of FIG. 8A taken along the cross-sectional line A-A, and FIG. 8C is a front view of a collimator lens;

FIG. 9 is a front view of the main portions of a partially modified example of the collimator lens in the optical pickup apparatus according to the third embodiment of the invention;

FIG. 10 is a flowchart showing a method for assembling the lens drive mechanism in a stepwise manner;

FIG. 11 is a flowchart showing a method for assembling the optical pickup apparatus apparatus in a stepwise manner;

FIG. 12 is a cross-sectional view of a lens driving apparatus 1 according to conventional techniques;

FIG. 13 is a plan view of an objective lens and a lens holder according to the conventional techniques;

FIG. 14 is a view schematically showing an optical pickup apparatus according to the conventional techniques;

FIGS. 15A and 15B show the objective lens according to the conventional techniques, wherein FIG. 15A is a plan view of the objective lens, and FIG. 15B is a cross-sectional view of the objective lens taken along the line A-A′; and

FIGS. 16A and 16B show the lens holder according to the conventional techniques, wherein FIG. 16A is a plan view of the lens holder, and FIG. 16B is a cross-sectional view of the lens holder taken along the line B-B′.

### DETAILED DESCRIPTION

Now referring to the drawings, preferred embodiments of the invention are described below.

Hereinafter, a plurality of embodiments of the invention are described with reference to the drawings. In the following description, a component corresponding to a component already described in a preceding embodiment may be denoted by the same reference numeral and may not be described in duplicate. In a case where only a portion of a component is described, the other portions of the component are the same as those that have been already described. In addition to the combination of components specifically described in each embodiment, it is also possible to partially combine components of embodiments as long as the combination causes no detriment. An optical pickup apparatus including a lens drive mechanism according to the embodiments of the invention is mounted on, for example, electronic equipment such as a personal computer and a disk reproducing apparatus. The following description includes a description of a method for assembling an objective lens, a method for assembling a lens drive mechanism, and a method for assembling an optical pickup apparatus.

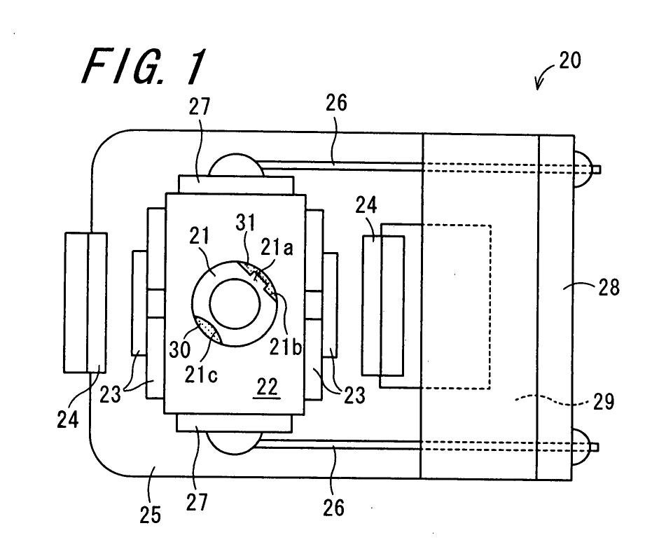

FIG. 1 is a plan view of a lens drive mechanism 20 according to a first embodiment of the invention. An optical pickup apparatus according to this embodiment is provided with a semiconductor laser serving as a light source, abeam splitter, a collimator lens, an erecting mirror, the lens drive mechanism 20 including an objective lens 21, a beam processing lens, and a detecting element.

The lens drive mechanism 20 includes the objective lens 21, a lens holder 22, coil members 23, magnet pieces 24 and a base plate 25. The objective lens 21 narrows a laser beam from the semiconductor laser and irradiates a recording disk serving as a recording medium with the laser beam. The lens holder 22 holds the objective lens 21. The coil members 23 are fixed to the lens holder 22. The magnet pieces 24 are opposed to the coil members 23. The magnet pieces 24 are fixed to a base plate 25. Furthermore, the lens drive mechanism 20 includes a plurality of wires 26, intermediate boards 27, a main board 28 and a damper holder 29. The plurality of wires 26 supply electricity from the outside to the coil members 23 and support the lens holder 22. The intermediate boards 27 are boards for electrically connecting the wires 26 and the coil members 23. The wires 26 are soldered to main board 28. The damper holder 29 is positioned between the main board 28 and the lens holder 22 and is filled with a damping material acting to dampen vibrations of a mechanical vibrating system constituted by the wires 26 and the lens holder 22.

When a laser beam emitted through the objective lens 21 toward the recording disk accurately traces spiral track formed on the rotating recording disk, the information recorded on the recording disk are read out, or information are written onto the recording disk. The electronic signals read and obtained by a detection element from the recording disk are processed in a control circuit (not shown), and error signals are generated that indicate the extent to which the objective lens 21 is displaced with respect to the optimum distance in the direction perpendicular to the recording disk, the optimum distance providing the optimum quality of the signals that are obtained from the recording disk. The obtained error signals are referred to as focus error signals. Similarly, the control circuit generates error signals that indicate whether or not the recording disk is accurately traced. The obtained error signals are referred to as tracking error signals.

Based on the focus error signals and the tracking error signals, the control circuit further generates signals for driving the objective lens, and sends control signals to the wires 26. The lens drive mechanism 20 constitutes a mechanical vibrating system that includes the wires 26, the damping material, and the lens holder 22, wherein the wires, the damping material, and the lens holder respectively correspond to a spring system, a damping system, and a mass. For the mechanical vibrating system, a magnetic circuit that includes the coil members 23, the magnet pieces 24, and the base plate 25 generates a magnetic force as an external force. In response to the signals for driving the objective lens, the magnetic circuit keeps the optimum relationship between the objective lens 21 and the recording disk, thereby making it possible to accurately read out information on the recording disk or to accurately record information onto the recording disk. This series of actions on the objective lens 21 is referred to as focus servo and tracking servo. The accuracy in control is deeply affected by factors such as the positional relationship, the precision in form, the rigidity, and the balance of movable portions, of the components constituting the lens drive mechanism 20.

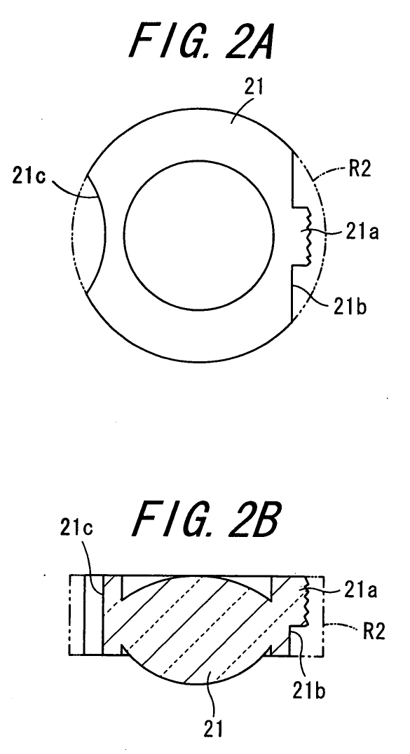

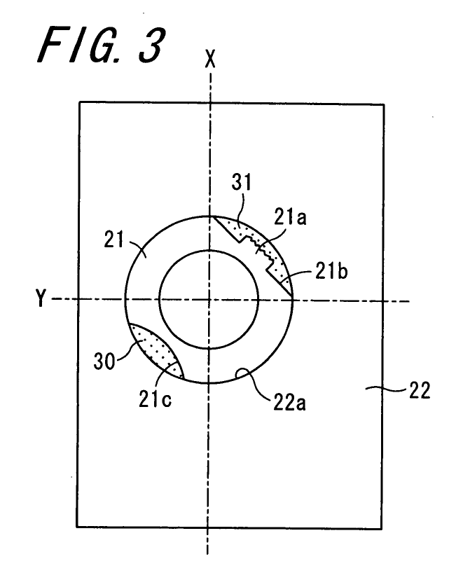

FIGS. 2A and 2B show the objective lens 21 according to the first embodiment of the invention. FIG. 2A is a plan view of the objective lens 21, and FIG. 2B is a cross-sectional view of the objective lens 21 taken along a virtual plane including an optical axis thereof. FIG. 3 is a plan view of the objective lens 21 and the lens holder 22 according to the first embodiment of the invention. The first embodiment is described below also with reference to FIG. 1.

The objective lens 21 objective lens according to the first embodiment of the invention is made of a molding material using a mold so as to have a substantially circular shape when viewed from above. The viewing from above is the same as viewing the objective lens 21 in the optical axial direction. A part of the objective lens 21 on the peripheral side in the radial direction is provided with a gate remainder 21a that is a part of a gate left in molding and a flat portion 21b for preventing the gate remainder 21a from protruding outward in the radial direction from a virtual circular circumference R2. The flat portion 21b is formed along a plane that is in parallel with a virtual plane including the optical axis. It should be noted that in order to prevent the gate remainder 21a from protruding outward in the radial direction from the virtual circular circumference R2, it is not always necessary to provide a flat portion. Instead of the flat portion 21b, for example, a recess may be formed at a part of the circumference of the objective lens 21. Also in this case, a similar effect to that of this embodiment is achieved.

In the position that is symmetrical, with respect to the optical axis, to the gate remainder 21a left on the peripheral side in the radial direction of the objective lens 21, is formed a recess portion 21c (referred to as an “objective lens recess portion 21c”) for correcting the weight imbalance of the lens holder 22 and the objective lens 21. More specifically, as shown in FIG. 2A, on the objective lens 21, the objective lens recess portion 21c facing outward in the radial direction is formed at the position that is symmetrical by 180 degrees to the gate remainder 21a with respect to the optical axis. A plurality of grooves that are to be filled with an adhesive are not necessary in the lens holder 21 for holding this objective lens 21.

The lens holder 22 is provided with a counterbore portion 22a to which the objective lens 21 is loosely, more specifically rotatably, fitted in a supported manner, and a through-hole portion that is coaxial with the counterbore portion 22a and that has a diameter smaller than that of the counterbore portion 22a. This through-hole portion secures the optical path. On the lens holder 22, in a state where the circumferential portion of the objective lens 21 is supported on the circular step portion serving as the counterbore portion 22a, the objective lens 21 can rotate about the optical axis relative to the lens holder 22. The objective lens 21 is rotated about the optical axis while the quality of a beam emitted through the objective lens is checked, and the rotation is stopped at the position where the quality of the beam emitted through the objective lens is optimum. In this state, a portion 30 facing the objective lens recess portion 21c, of the counterbore portion 22a of the lens holder 22, is filled with an adhesive, and a portion 31 facing the gate remainder 21a, of the counterbore portion 22a of the lens holder 22, is filled with an adhesive in the same amount as the adhesive.

The shape and the size of the objective lens recess portion 21c are determined such that the weight balance of the lens holder 22 and the objective lens 21 can be kept. In other words, the volume of the portion 30 facing the objective lens recess portion 21c, of the counterbore portion 22a of the lens holder 22, is designed to be the same as the volume of the portion 31 facing the gate remainder 21a and the flat portion 21b, of the counterbore portion 22a of the lens holder 22. More specifically, a remaining portion obtained by eliminating the lens on which the objective lens recess portion 21c is formed and the gate remainder 21a is left, from a virtual lens formed by the virtual circular circumference R2, is defined to have the same volumes at the symmetrical positions with respect to the optical axis. Thus, the centroid of the objective lens 21 is disposed on the optical axis of this lens. Furthermore, in this embodiment, the difference in specific gravity between the adhesive used for filling and the molding material forming the objective lens 21 is taken into consideration.

On the objective lens 21 described above, the gate remainder 21a that is a part of a gate left in molding is on the lens, but the centroid of the lens is on the optical axis of the lens, and thus the weight balance of the objective lens 21 can be kept in a well-balanced state. Thus, the weight balance of the lens holder 22 holding the objective lens 21 also can be kept easily and in a well-balanced state. Accordingly, compared with conventional techniques, the dynamic characteristics of the optical pickup apparatus including the objective lens 21 can be stabilized, and the recording disk can be accurately traced. It is possible to keep the weight balance in a well-balanced state without increasing the mass of the lens holder 22 for holding the objective lens 21 and the like, and thus the first lens drive mechanism 20 can be made lighter. Compared with, for example, a case in which the mass of the lens holder 22 is made larger than the original mass, the control characteristics can be improved, and the recording disk rotating at a high speed can be easily traced.

On the objective lens 21, the gate remainder 21a is left on the peripheral side in the radial direction, and the objective lens recess portion 21c is formed at the position that is symmetrical with respect to the optical axis (position that is symmetrical by 180 degrees) to the gate remainder 21a on the objective lens 21. In a state where the objective lens 21 is held on the counterbore portion 22a of the lens holder 22, the objective lens 21 is rotated about the optical axis to a desired position, and then an adhesive is applied to the portion 31 facing the gate remainder 21a and the flat portion 21b, and the portion 30 facing the objective lens recess portion 21c, of the counterbore portion 22a of the lens holder 22. Thus, the objective lens 21 can be fixed to the lens holder 22, and the lens holder 22 and the objective lens 21 can be kept in a well-balanced state without disturbing the weight balance.

Thus, compared with conventional techniques, the dynamic characteristics of the lens drive mechanism 20 including the objective lens 21 can be stabilized, and the recording disk can be accurately traced. It is possible to keep the weight balance in a well-balanced state without increasing the mass of the lens holder 22 for holding the objective lens 21 and the like, and thus the lens drive mechanism 20 can be made lighter. Compared with, for example, a case in which the mass of the lens holder 22 is made larger than the original mass, the control characteristics can be improved, and the recording disk rotating at a high speed can be easily traced.

The objective lens 21 is fixed to the lens holder 22 using an adhesive at the gate remainder 21a and the objective lens recess portion 21c, and thus the weight balance of the lens holder 22 and the objective lens 21 can be reliably and easily kept in a well-balanced state. The volume of the portion 30 facing the objective lens recess portion 21c, of the counterbore portion 22a of the lens holder 22, is designed to be the same as the volume of the portion 31 facing the gate remainder 21a and the flat portion 21b, of the counterbore portion 22a of the lens holder 22. Thus, management is possible such that the amount of the adhesive applied to the gate remainder 21a is the same as the amount of the adhesive applied to the objective lens recess portion 21c.

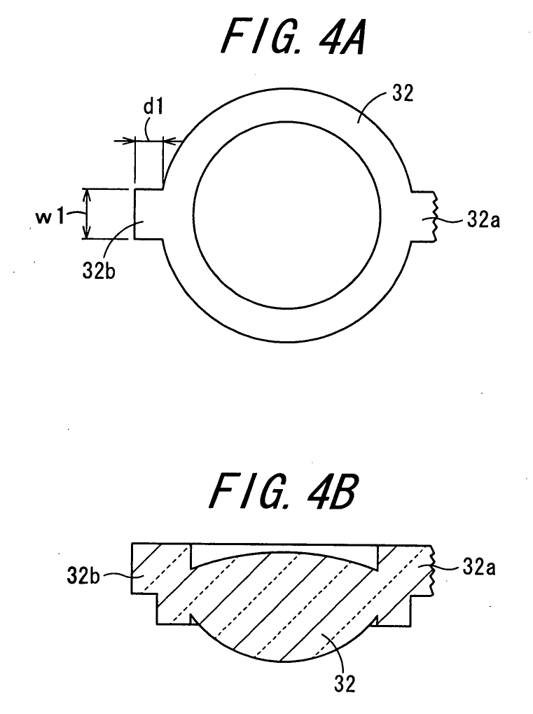

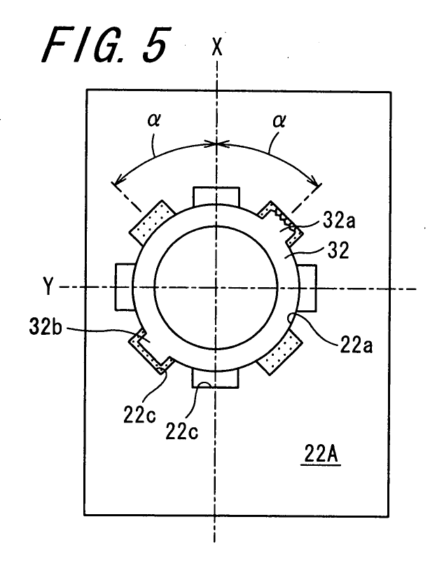

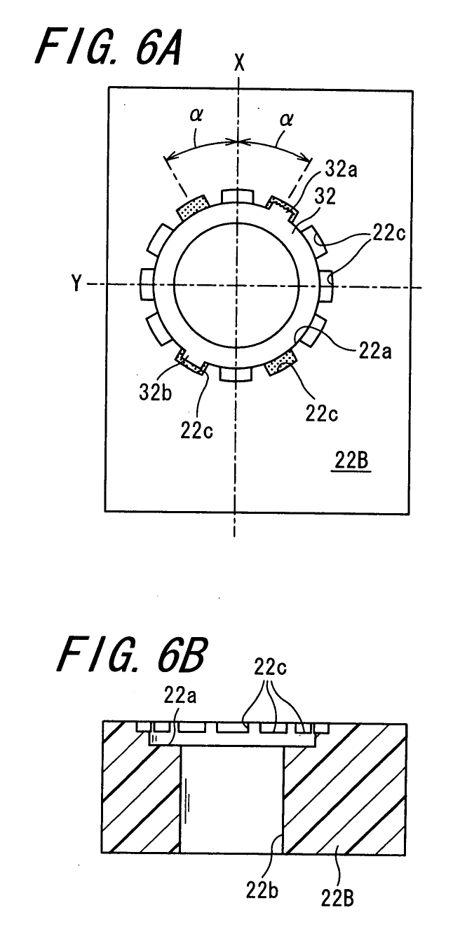

FIGS. 4A and 4B show an objective lens 32 according to a second embodiment of the invention. FIG. 4A is a plan view of the objective lens 32, and FIG. 4B is a cross-sectional view of the objective lens 32 taken along a virtual plane including an optical axis thereof. FIG. 5 is a plan view of the objective lens 32 and a lens holder 22A according to the second embodiment. FIGS. 6A and 6B are views showing a lens holder 22B. FIG. 6A is a plan view of the lens holder 22B, and FIG. 6B is a cross-sectional view of the lens holder 22B.

The objective lens 32 according to the second embodiment of the invention is made of a molding material using a mold so as to have a substantially circular shape when viewed from above. The circumferential portion of the objective lens 32 is provided with a gate remainder 32a that protrudes outward in the radial direction from the circumferential portion by a short distance, and that is a part of a gate left in molding. In the position that is symmetrical, with respect to the optical axis, to the gate remainder 32a on the objective lens 32, is formed a projecting portion 32b (referred to as a “balance projecting portion 32b”) for correcting the weight imbalance of the lens holder 22A, 22B, and the objective lens 32. More specifically, as shown in FIG. 4A, on the objective lens 32, in the position that is symmetrical by 180 degrees to the gate remainder 32a with respect to the optical axis, is formed the balance projecting portion 32b that protrudes outward in the radial direction from the circumferential portion by a predetermined short distance. The flat portion 21b as in the objective lens 21 is not necessary for the objective lens 32. A protruding amount d1 and a width w1 of the balance projecting portion 32b are determined based on the volume of the gate remainder 32a. More specifically, the volume of the balance projecting portion 32b is designed to be the same as the volume of the gate remainder 32a.

The lens holder 22A, 22B for holding the objective lens 32, according to the second embodiment of the invention, is provided with the counterbore portion 22a that supports the objective lens 32, a through-hole portion 22b that secures the optical path, and a plurality of groove portions 22c. As shown in FIG. 5, on the lens holder 22A, a surface portion at the inner circumferential edge portion of the counterbore portion 22a is provided with the plurality of groove portions 22c at every angle α, to which at least the gate remainder 32a and the balance projecting portion 32b can be fitted. The groove portions 22c are radially formed so as to extend outward in the radial direction from the counterbore portion 22a by a predetermined short distance, based on the size of the gate remainder 32a and the balance projecting portion 32b. It should be noted that although α=45 degrees in FIG. 5, the angle is not limited to 45 degrees as long as it is an angle by which 360 degrees can be equally divided into an even number.

In a state where the objective lens 32 is held on the lens holder 22A, 22B, a laser beam is emitted, and the quality of the laser beam is checked while the objective lens 32 is rotated by every angle α with respect to the lens holder 22A, 22B. When the objective lens 32 is at the position where the relative angle with respect to the lens holder 22A, 22B is optimum, two groove portions 22c to which the gate remainder 32a and the balance projecting portion 32b are fitted are filled with an adhesive, and thus the objective lens 32 is fixed to the lens holder 22A, 22B. Herein, the direction that is in parallel with the longitudinal direction of the lens holder 22A, 22B and that is perpendicular to the optical axis direction is taken as a reference X axis. The direction that is perpendicular to the optical axis direction and the reference X axis is taken as a reference Y axis. In FIGS. 5 and 6A, the reference X axis is indicated by the line X, and the reference Y axis is indicated by the line Y.

In a case where the gate remainder 32a or the balance projecting portion 32b is not fitted to the groove portions 22c arranged on the reference X axis and the reference Y axis on the lens holder 22A, 22B, taking the weight balance of the lens holder 22A, 22B, and the objective lens 32 into consideration, the groove portions 22c (shaded portions in FIGS. 5 and 6A) that are symmetric with respect to the X axis and the Y axis to the groove portions 22c to which the gate remainder 32a and the balance projecting portion 32b are fitted are filled with an additional adhesive. Thus, it is possible to further suppress the weight imbalance. On the lens holder 22A shown in FIG. 5, after the groove portions 22c to which the gate remainder 32a and the balance projecting portion 32b are fitted are filled with a predetermined amount of adhesive, taking weight balance in the reference X axis direction and the reference Y axis direction into consideration, the groove portions 22c (shaded portions in FIG. 5) obtained by shifting the phase by 90 degrees from the above-described groove portions 22c are both filled with an additional adhesive. For the lens holder 22B shown in FIGS. 6A and 6B, after the groove portions 22c to which the gate remainder 32a and the balance projecting portion 32b are fitted are filled with a predetermined amount of adhesive, taking weight balance in the reference X axis direction and the reference Y axis direction into consideration, the groove portions 22c (shaded portions in FIG. 6A) corresponding to the positions that are symmetrical to the above-described groove portions 22c with respect to the X axis and the Y axis are both filled with an additional adhesive. Thus, it is possible to correct the weight imbalance of the lens holders.

With the lens holder 22A, 22B, and the objective lens 32 described above, the objective lens 32 can be fixed to the lens holder 22A, 22B, and the lens holder 22A, 22B, and the objective lens 32 can be kept in a well-balanced state without disturbing the weight balance. In an application example of the second embodiment of the invention, the weight balance of the entire lens holder can be kept in a well-balanced state without forming grooves on the lens holder in advance, by providing the objective lens 32 so as to be rotatable about the optical axis with respect to the lens holder, and applying an adhesive. In this case, the configuration of the lens holder can be simplified, and thus the cost for the mold can be reduced.

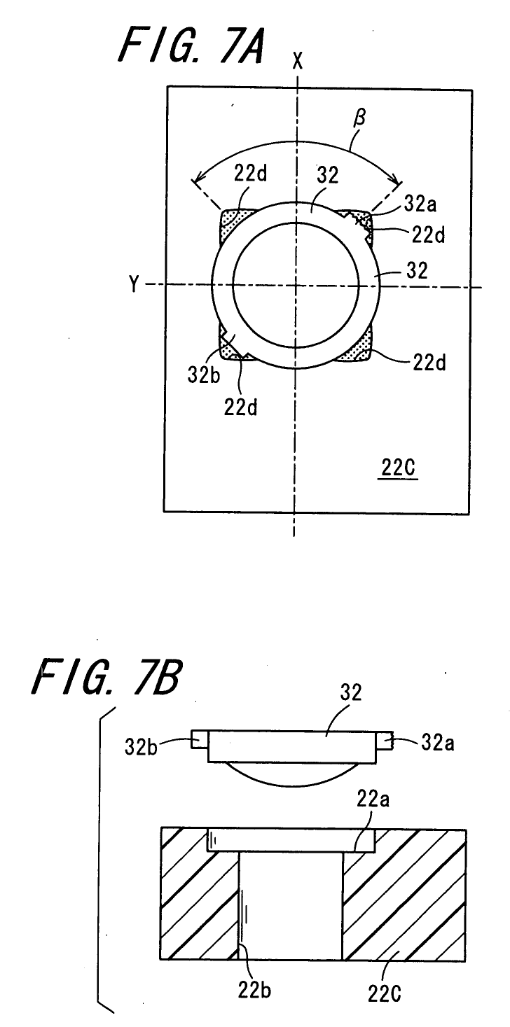

FIGS. 7A and 7B are views showing the relationship between the objective lens 32 and a lens holder 22C according to a partially modified example of the second embodiment. FIG. 7A is a plan view of the lens holder 22C and other components, and FIG. 7B is a cross-sectional view of the lens holder 22C and other components. The lens holder 22C for holding the objective lens 32, according to this modified example, is provided with the counterbore portion 22a to which the objective lens 32 is loosely, more specifically rotatably, fitted in a supported manner, the through-hole portion 22b that secures the optical path, and groove portions 22d. On the lens holder 22C, a surface portion at the inner circumferential edge portion of the counterbore portion 22a is provided with the groove portions 22d at every angle β, to which at least the gate remainder 32a and the balance projecting portion 32b can be fitted. The groove portions 22d are radially formed so as to extend outward in the radial direction from the counterbore portion 22a by a predetermined short distance and to have a narrower width as being on the outer side in the radial direction, based on the size of the gate remainder 32a and the balance projecting portion 32b. This shape of the grooves enables the gate remainder 32a and the balance projecting portion 32b to be fixed at the positions where these portions are stably placed. It should be noted that although β=90 degrees in FIG. 7A, the angle is not limited to 90 degrees as long as it is an angle by which 360 degrees can be equally divided into an even number.

In a state where the objective lens 32 is held on the lens holder 22C, a laser beam is emitted, and the quality of the laser beam is checked while the objective lens 32 is rotated by every angle β with respect to the lens holder 22C. When the objective lens 32 is at the position where the relative angle with respect to the lens holder 22C is optimum, two groove portions 22d to which the gate remainder 32a and the balance projecting portion 32b are fitted are filled with an adhesive, and thus the objective lens 32 is fixed to the lens holder 22C. Furthermore, on the lens holder 22C, two groove portions 22d to which neither the gate remainder 32a nor the balance projecting portion 32b is fitted are also filled with an adhesive. Thus, it is possible to suppress the weight imbalance of the lens holder 22C and the objective lens 32.

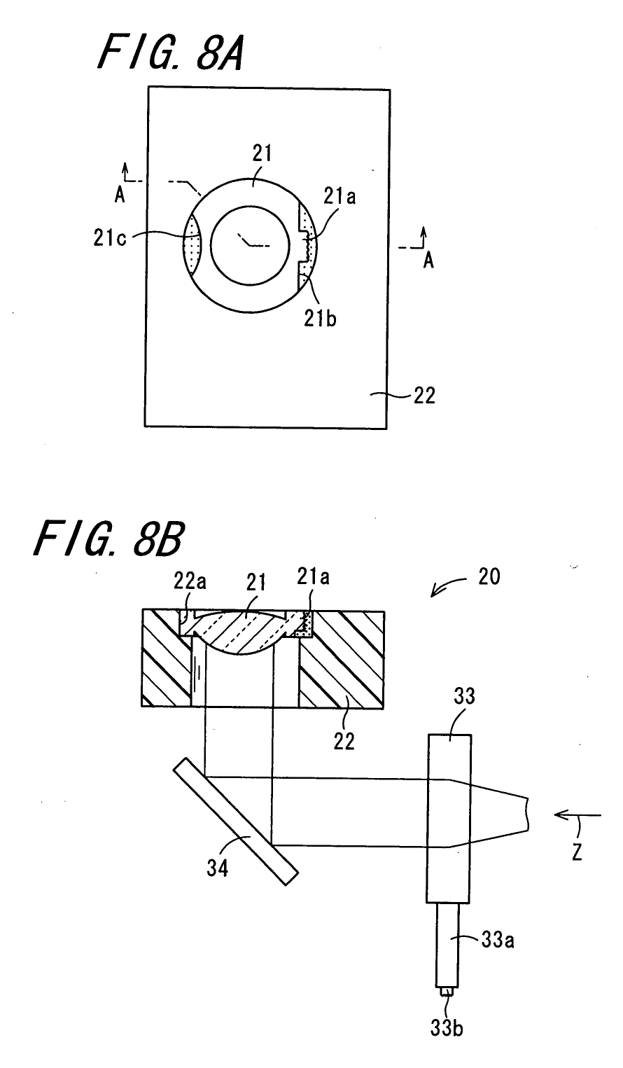

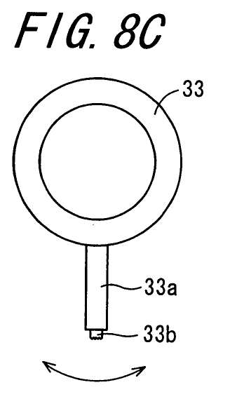

FIGS. 8A through 8C show the main portions of an optical pickup apparatus according to a third embodiment of the invention. FIG. 8A is a plan view of the objective lens 21 and the lens holder, FIG. 8B is a cross-sectional view of FIG. 8A taken along the cross-sectional line A-A, and FIG. 8C is a front view of a collimator lens 33. The optical pickup apparatus according to the third embodiment of the invention is provided with a semiconductor laser serving as a light source, a beam splitter, the collimator lens 33 having a rotating lever 33a as adjusting section for adjusting the rotation of the collimator lens about the optical axis thereof, an erecting mirror 34, the lens drive mechanism 20 including the objective lens 21, a beam processing lens, and a detecting element. The collimator lens 33 is composed of a molded piece formed by pouring a molding material into a mold.

In the lens drive mechanism 20, regarding the objective lens that is to be fixed to the lens holder 22, it is necessary to give the highest priority to suppression of the weight imbalance of the lens holder 22. Thus, for example, using the objective lens 21, the objective lens 21 is positioned so as to adhere to the lens holder 22 in the direction that provides the optimum rotational balance of the lens holder 22 with respect to the reference X axis and the reference Y axis.

On the other hand, the quality of a laser beam emitted through the objective lens 21 is optimized by rotating the collimator lens 33 combined with the optical pickup apparatus about the optical axis thereof (indicated by the arrow Z in FIG. 8B). In this embodiment, in order to optimize the quality of a laser beam emitted through the objective lens, which depends on residual strain of the collimator lens 33 itself and residual strain of the objective lens 21 itself, the strains are allowed to be cancelled each other by rotating at least one of the objective lens 21 and the collimator lens 33, thereby optimizing the quality. In this manner, residual strain of the collimator lens 33 and residual strain of the objective lens 21 can be cancelled each other, and thus the quality of a laser beam can be optimized more than those in the first and the second embodiments. On the other hand, in the first and the second embodiments, residual strain is minimized by rotating the objective lens, and thus the quality of a laser beam is optimized.

The circumferential portion of the collimator lens 33 is provided with a rotating lever 33a which is shaped in a rod and protrudes outward in the radial direction from the circumferential portion. The rotating lever 33a is provided with a gate portion 33b. The collimator lens 33 is kept in a state where the circumferential portion can be rotated about the optical axis thereof. After it is confirmed that the quality of a beam emitted through the objective lens 21 has been optimized while the rotating lever 33a is held and the circumferential portion is rotated about the optical axis, the collimator lens 33 is unrotatably fixed using an adhesive. Thus, the optimized quality of the laser beam can be maintained.

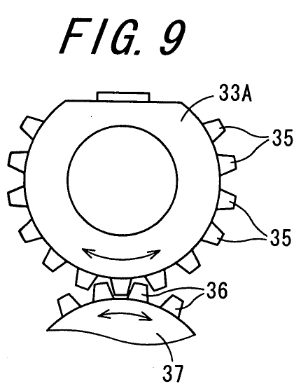

FIG. 9 is a front view of the main portions of a partially modified example of the collimator lens in the optical pickup apparatus according to the third embodiment of the invention. The circumferential portion of a collimator lens 33A according to this embodiment is provided with a plurality of gear-shaped projecting portions 35 at a predetermined interval in the circumferential direction. An adjusting device 37 includes a plurality of adjustment projecting portions 36 that are meshed with the gear-shaped projecting portions 35. The circumferential portion provided with the adjustment projecting portions 36 of the adjusting device 37 is configured so as to be rotatable, and can be driven to rotate at any angle using a driving source (not shown). The circumferential portion of the adjusting device 37 is driven to rotate, so that the adjustment projecting portions 36 are rotated, and the collimator lens 33A is rotated about the optical axis thereof. In this state, when it is confirmed that the quality of a beam emitted through the objective lens 21 has been optimized, the driving source is stopped, and thus the optimized quality of the laser beam can be maintained.

In this embodiment, it is possible to rotate the collimator lens 33A about the optical axis thereof in order to regularly (or irregularly) optimize the quality of a laser beam emitted through the objective lens 21. It is not necessary that the collimator lens 33A is unrotatably fixed, and thus the adjustment operation can be simplified. It would be appreciated that also in this embodiment, the collimator lens 33A may be unrotatably fixed using an adhesive, after it is confirmed that the quality of a beam emitted through the objective lens 21 has been optimized.

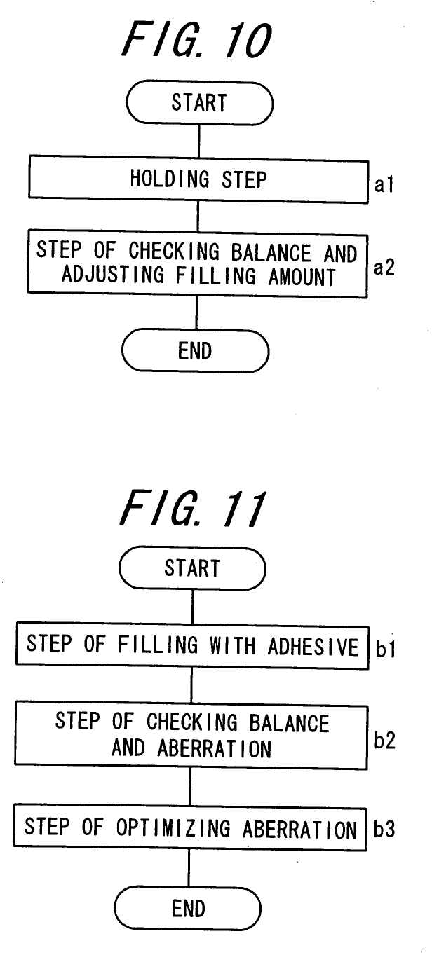

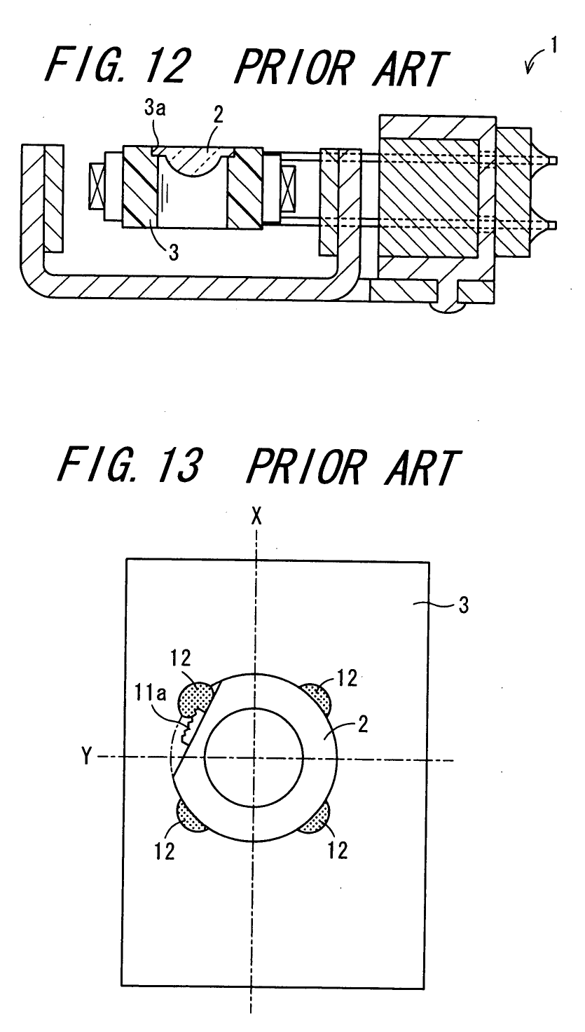

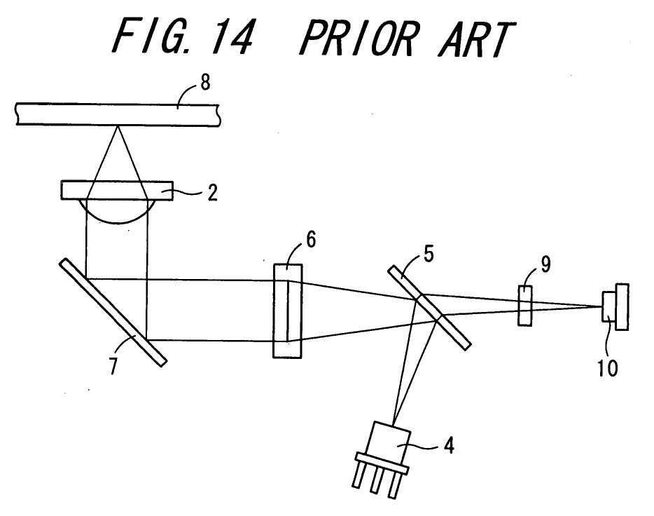

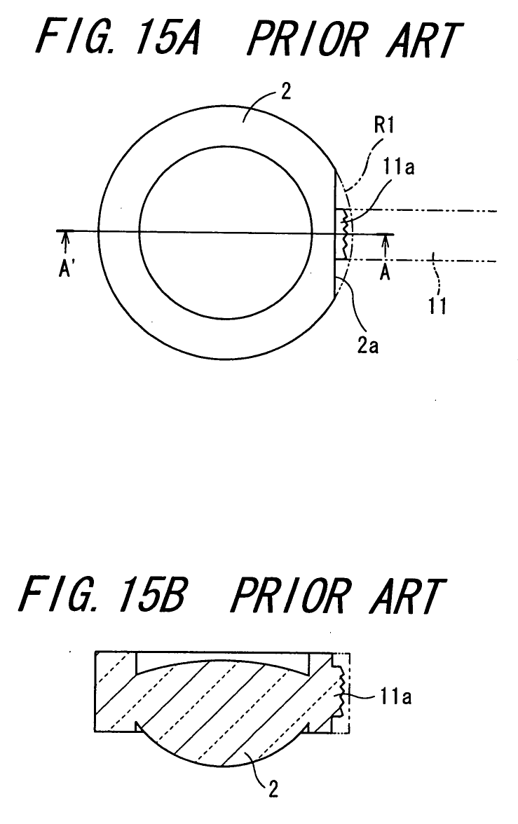

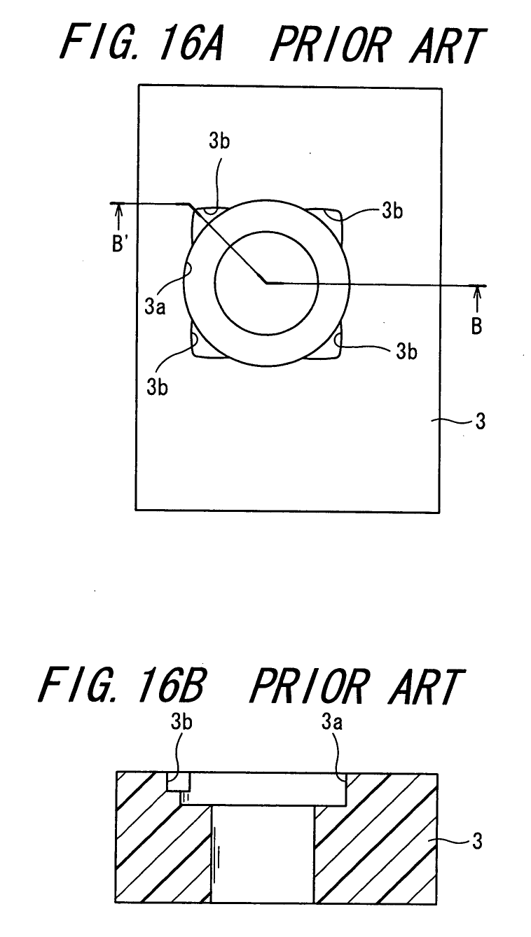

FIG. 10 is a flowchart showing a method for assembling the lens drive mechanism in a stepwise manner. Correction of the imbalance of the lens holder according to this embodiment is described with reference to the lens drive mechanism 20 according to the first embodiment of the invention. In step al, the objective lens 21 is held on the lens holder 22. Next, the procedure proceeds to step a2, where the portion 30 facing the objective lens recess portion 21c and the portion 31 facing the gate remainder 21a, of the counterbore portion 22a of the lens holder 22, are filled with an adhesive. In this step a2, the portion 30 facing the objective lens recess portion 21c and the portion 31 facing the gate remainder 21a and the flat portion 21b are filled with an additional adhesive while the entire movable portion including the lens holder 22 is swung in the focus direction, that is, the direction perpendicular to the X axis and the Y axis, and in the tracking direction, and the level of unwanted vibrations caused by the lens holder is checked, and thus this imbalance is suppressed. Then, this flow ends.

A description is also made regarding the second embodiment of the invention. In step al, the objective lens 32 is held on the lens holder 22A, 22B. Next, the procedure proceeds to step a2, where two groove portions 22c to which the gate remainder 32a and the balance projecting portion 32b are fitted are filled with an adhesive, and thus the objective lens 32 is fixed to the lens holder 22A, 22B. In this step a2, the groove portions 22c to which neither the gate remainder 32a nor the balance projecting portion 32b is fitted are filled with an adhesive while the entire movable portion including the lens holder 22A, 22B is swung in the focus direction and in the tracking direction, and the level of unwanted vibrations caused by the imbalance is checked. After it is confirmed that the level of unwanted vibrations has been lowered, this flow ends.

An example of a method for checking the level of unwanted vibrations is described. The level of unwanted vibrations can be checked using apparatuses such as an autocollimator, which is a measuring apparatus for optically measuring the angle of an optical component inclined. More specifically, when the lens holder is driven at a specific frequency in the optical axial direction or the direction perpendicular to the optical axial direction, a state in which the inclination of the lens holder is increased in accordance with the level of unwanted vibrations can be observed by monitoring, with the autocollimator, a beam reflected by a movable portion such as a lens. Furthermore, the frequency of unwanted vibrations tends to be a specific frequency because of the configuration. Using this aspect, the level of unwanted vibrations can be checked. It should be noted that the level of unwanted vibrations may be checked using a measuring apparatus, other than the autocollimator, capable of precisely measuring the angle of an optical component.

FIG. 11 is a flowchart showing a method for assembling the optical pickup apparatus in a stepwise manner. A method for optimizing aberration and the like are described with reference to the optical pickup apparatus according to the third embodiment of the invention. In step b1, the objective lens 21 is fixed using an adhesive to a predetermined rotational position on the lens holder 22. Thus, the imbalance of the lens holder 22 is corrected. Next, the procedure proceeds to step b2, where the balance of the lens holder 22 and the aberration of a laser beam are checked.

Even when the balance of the lens holder has been optimized in step b1, it is also expected that the aberration of a laser beam cannot be optimized. In particular, in a case where information is read from a recording disk recording signals at a high density or a case in which information is written onto a recording disk at a high density, it is also expected that correction of the imbalance of the lens holder 22 and optimization of the aberration of a laser beam cannot be achieved together. Thus, the procedure proceeds to step b3, where the aberration is optimized by rotating the collimator lens 33 about the optical axis thereof, and the collimator lens 33 is unrotatably fixed, so that the performance of the optical pickup apparatus can be made higher. Then, the flow ends.

Even when the objective lens according to this embodiment is rotated about the optical axis thereof, the weight balance of the lens holder holding the objective lens can be kept. Thus, the quality of signals that are read out can be kept high. With the lens drive mechanism according to this embodiment, management of an adhesive can be simplified compared with conventional techniques, and thus the productivity can be improved. A significant effect can be achieved by applying the lens drive mechanism according to this embodiment to existing media such as compact disks (abbreviated as CDs) and digital versatile disks (abbreviated as DVDs), high-density recording media using blue laser, or the like. In addition, the invention may be practiced in variously modified forms within the scope not departing from the gist of the invention.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An objective lens mounted on a lens drive mechanism of an optical pickup apparatus that performs at least one of reading out information recorded on a recording medium and writing information onto a recording medium, by irradiating the recording medium with a beam from a light source, comprising:
a lens composed of a molded piece, having a gate remainder that is a part of a gate left in molding, and having a centroid positioned on its optical axis.

2. The objective lens of claim 1, wherein a recess portion is formed on the objective lens at a position that is symmetrical, with respect to the optical axis, to the gate remainder formed on a peripheral side in a radial direction.

3. The objective lens of claim 2, wherein the gate remainder and the recess portion are fixed to a lens holder through an adhesive.

4. The objective lens of claim 3, wherein the gate remainder and the recess portion are arranged on an inner side in a radial direction of a virtual circular circumference of the lens, and
a remaining portion obtained by eliminating the lens on which the gate remainder is left and the recess portion is formed, from a virtual lens formed by the virtual circular circumference, is defined to have the same volumes at symmetrical positions with respect to the optical axis.

5. The objective lens of claim 1, wherein the gate remainder is left on a peripheral side in the radial direction of the lens, and a projecting portion having the same volume as the gate remainder is provided at a position that is symmetrical, with respect to the optical axis, to the gate remainder on the lens.

6. The objective lens of claim 5, wherein the gate remainder and the projecting portion are fixed to a lens holder through an adhesive.

7. A lens drive mechanism comprising:
an objective lens including a lens composed of a molded piece, having a gate remainder that is a part of a gate left in molding, and having a centroid positioned on its optical axis; and
a lens holder on which an objective lens is mounted.

8. The lens drive mechanism of claim 7, wherein the lens holder holds the objective lens such that the objective lens can rotate about the optical axis thereof.

9. The lens drive mechanism of claim 7, wherein the gate remainder is left on a peripheral side in a radial direction of the lens,
a projecting portion having the same volume as that of the gate remainder is provided at a position that is symmetrical, with respect to the optical axis, to the gate remainder on the lens, and
a plurality of groove portions that can accommodate the gate remainder and the projecting portion are arranged on the lens holder such that adjacent groove portions are formed at an equal angle.

10. An optical pickup apparatus on which the lens drive mechanism of claim 7 is mounted.

11. The optical pickup apparatus of claim 10, wherein a collimator lens having an adjusting section for adjusting rotation about the optical axis is provided on an optical path between the objective lens and a light source of the optical pickup apparatus including the lens drive mechanism.

12. A method for assembling a lens drive mechanism of an optical pickup apparatus, comprising:
a step of holding an objective lens on a counterbore portion that is formed in a lens holder in advance, the objective lens composed of a molded piece, having a gate remainder that is a part of a gate left in molding and is left on a peripheral side in radial direction of the lens, and a recess portion or projecting portion being formed at a position that is symmetrical to the gate remainder with respect to an optical axis; and
a step of applying an adhesive to a portion facing the recess portion or projecting portion, of the counterbore portion of the lens holder, and applying an adhesive in the same amount as the amount of the adhesive, to a portion facing the gate remainder, of the counterbore portion of the lens holder.

13. The method of claim 12, wherein, in the step of applying the adhesive, the adhesive is dropped onto the portion facing the recess portion on the objective lens, of the counterbore portion of the lens holder, and the portion facing the gate remainder such that the adhesive does not bulge out from the counterbore portion of the lens holder.

14. The method of claim 12, further comprising a step of adjusting the amount of the adhesive used for filling such that the objective lens is fixed to the lens holder, while checking the balance of the lens holder.

15. A method for assembling an optical pickup apparatus, comprising:
a step of holding an objective lens on a counterbore portion that is formed in a lens holder in advance, the objective lens composed of a molded piece, having a gate remainder that is a part of a gate left in molding and is left on a peripheral side in radial direction of the lens, and a recess portion or projecting portion being formed at a position that is symmetrical to the gate remainder with respect to an optical axis;
a step of applying an adhesive to a portion facing the recess portion or projecting portion, of the counterbore portion of the lens holder, and applying an adhesive in the same amount as the amount of the adhesive, to a portion facing the gate remainder, of the counterbore portion of the lens holder;
a step of checking a balance of the lens holder and aberration of a beam emitted from a light source of the optical pickup apparatus, after the step of applying the adhesive; and
a step of optimizing the aberration based on check results of the balance and the aberration.
